(19) United States
(12) Patent Application Publication
(10) Pub. No.: US 2019/0146296 A1
(43) Pub. Date: May 16, 2019

(54) VARIABLE OPTICAL ATTENUATOR

(71) Applicant: Electronics and Telecommunications Research Institute, Daejeon (KR)

(72) Inventors: CHAN IL YEO, Gwangju (KR); Dong Hoon SON, Jeollanam-do (KR); Hyun Seo KANG, Gwangju (KR); Keo-Sik KIM, Gwangju (KR); Kyeeun KIM, Gwangju (KR); Sung Chang KIM, Gwangju (KR); Ji Hyoung RYU, Jeonju-si Jeollabuk-do (KR); Gi Hyeon MIN, Gwangju (KR); Si Woong PARK, Gwangju (KR); Hyoungjun PARK, Gwangju (KR); Dongsoo LEE, Yongin-si Gyeonggi-do (KR); Young Soon HEO, Gwangju (KR)

(73) Assignee: Electronics and Telecommunications Research Institute, Daejeon (KR)

(21) Appl. No.: 15/918,718

(22) Filed: Mar. 12, 2018

(30) Foreign Application Priority Data
Nov. 16, 2017 (KR) 10-2017-0153285

(51) Int. Cl. G02F 1/163; G02F 1/133; G02F 1/157; G02F 1/1335

(52) U.S. Cl. CPC G02F 1/163; G02F 1/13318; G02F 2203/48; G02F 1/133514; G02F 1/133526; G02F 1/157

(57) ABSTRACT

Disclosed is a variable optical attenuator. The variable optical attenuator includes an electrochromic device having a reflective property or a transflective property, a lens configured to convert input light to focused light or collimated light and input the focused light or the collimated light to the electrochromic device, and an outputter configured to output light reflected from the electrochromic device, in which the electrochromic device is configured to attenuate an intensity of the input light by controlling a reflectivity and a transmissivity of the input light based on an element included in the electrochromic device and a voltage to be applied to the electrochromic device.

### CROSS-REFERENCE TO RELATED APPLICATIONS

This application claims the priority benefit of Korean Patent Application No. 10-2017-0153285 filed on Nov. 16, 2017, in the Korean Intellectual Property Office, the disclosure of which is incorporated herein by reference for all purposes.

### BACKGROUND

### 1. Field

One or more example embodiments relate to a variable optical attenuator configured to monitor an intensity of input light and adjust an intensity to be attenuated based on the monitoring.

### 2. Description of Related Art

A variable optical attenuator refers to a device that is widely used in various fields of applications, for example, attenuation of optical power of each channel for each wavelength in an optic communication system using, for example, wavelength division multiplexing, and characteristic tests for optical power used in optical systems and devices. A variable optical attenuation method used to attenuate power of incident light and output the attenuated power may encompass a wide range of methods related to, for example, a microelectromechanical system (MEMS), a planar lightwave circuit (PLC), an actuator, a nonlinear effect, a thermooptical effect, a magnetooptical effect, a liquid crystal, and the like.

As optical devices and systems have become gradually smaller in size and lower in price, continued efforts have been made to reduce a size of a variable optical attenuator by reducing the number of optical components used for the variable optical attenuator and increasing a degree of integration thereof, and to enhance a production efficiency and reduce a production cost by improving an optical alignment reliability and streamlining a packaging process.

For example, an MEMS technology-based variable optical attenuator using an actuator shutter, as disclosed in Korean Patent Publication No. 2004-0087675, serves as an example of existing variable optical attenuation methods. The MEMS technology-based variable optical attenuator may be vulnerable to vibration, and require a high level of voltage for a movement of an actuator and have an attenuation ratio that changes rapidly when an optical alignment is dislocated by a mechanical movement, and thus may experience issues related to stability and reliability. Further, there may also arise other issues, such as, for example, occurrence of diffraction dependent on a wavelength at an edge of the shutter and occurrence of a polarization-dependent loss. Moreover, such an existing attenuator may have an entire package that is relatively large in size due to a relatively large actuator.

Thus, there is a desire for a variable optical attenuator that is simpler in structure compared to a variable optical attenuator using a physical movement, and also adaptively changes an intensity to be attenuated.

### SUMMARY

An aspect provides a device that may adaptively change an intensity of input light to be attenuated by controlling an amount, or an intensity, of light to be reflected or transmitted using an electrochromic device configured to control a reflectivity and a transmissivity by adjusting a light absorptivity based on a voltage to be applied thereto.

Another aspect also provides a device that may adaptively change an intensity of input light to be attenuated based on a change in optical power of the input light by monitoring total optical power of the input light by monitoring a portion of the optical power through a filter or a splitter, or monitoring total optical power of the input light using light transmitted from an electrochromic device having a transflective property, and by changing an intensity of the input light to be attenuated based on a result of the monitoring.

According to an aspect, there is provided a variable optical attenuator including an electrochromic device having a reflective property or a transflective property, a lens configured to convert input light to focused light or collimated light and input the focused light or the collimated light to the electrochromic device, and an outputter configured to output light reflected from the electrochromic device. The electrochromic device may attenuate an intensity of the input light by controlling a reflectivity and a transmissivity of the input light based on an element included in the electrochromic device and a voltage to be applied to the electrochromic device.

When the electrochromic device has the transflective property, the variable optical attenuator may further include an optical detector configured to monitor a portion of the input light transmitted from the electrochromic device. Herein, the voltage to be applied to the electrochromic device may be determined based on a result of the monitoring of the light transmitted from the electrochromic device.

The electrochromic device may include a first face configured to transmit a portion of the input light and reflect, at an angle of 90 degrees (°), a remaining portion of the input light that is not transmitted, and a second face configured to reflect the light reflected from the first face in a direction in which the outputter is disposed.

The variable optical attenuator may further include a filter configured to filter out a remaining wavelength, excluding a specific wavelength, among wavelengths included in the input light, and the electrochromic device may attenuate an intensity of light with the specific wavelength transmitted from the filter. The lens may form a focal point to input, to the outputter, the light reflected from the electrochromic device.

According to another aspect, there is provided a variable optical attenuator including an electrochromic device having a transmissive property, a first lens configured to convert input light to focused light or collimated light and input the focused light or the collimated light to the electrochromic device, and an outputter configured to output the input light transmitted from the electrochromic device. The electrochromic device may attenuate an intensity of the input light by controlling a transmissivity of the input light based on an element included in the electrochromic device and a voltage to be applied to the electrochromic device.

The variable optical attenuator may further include a filter configured to split a portion of the input light and an optical detector configured to monitor optical power of the split light. Thus, by monitoring total optical power of the input light through the monitoring of the portion of the input light obtained through the filter, the variable optical attenuator may adaptively control an amount, or an intensity, of the input light to be attenuated. The variable optical attenuator may further include a second lens configured to form a focal point to input, to the outputter, the light transmitted from the electrochromic device.

According to still another aspect, there is provided a variable optical attenuator including an electrochromic device having a reflective property, a first lens configured to convert input light to focused light or collimated light and input the focused light or the collimated light to the electrochromic device, and an outputter configured to output the input light reflected from the electrochromic device. The electrochromic device may attenuate an intensity of the input light by controlling a reflectivity of the input light based on an element included in the electrochromic device and a voltage to be applied to the electrochromic device.

The variable optical attenuator may further include a filter configured to split a portion of the input light and an optical detector configured to monitor optical power of the split light. Thus, by monitoring total optical power of the input light through the monitoring of the portion of the input light obtained through the filter, the variable optical attenuator may adaptively control an amount, or an intensity, of the input light to be attenuated.

The first lens may form a focal point to input, to the outputter, the light reflected from the electrochromic device.

According to yet another aspect, there is provided a variable optical attenuator including an inputter configured to output input light including a plurality of wavelengths, a first lens configured to convert the input light to focused light or collimated light and input the focused light or the collimated light to an attenuator, a filter configured to transmit a specific wavelength among the wavelengths included in the input light, the attenuator configured to attenuate light with the specific wavelength and reflect the attenuated light with the specific wavelength, an outputter configured to output the light with the specific wavelength reflected from the attenuator, and an optical detector configured to monitor optical power of light transmitted from the attenuator.

According to further another aspect, there is provided a variable optical attenuator including an inputter configured to output input light including a plurality of wavelengths, a first lens configured to convert the input light to focused light or collimated light and input the focused light or the collimated light to an attenuator, a filter configured to transmit a specific wavelength among the wavelengths included in the input light, the attenuator configured to attenuate light with the specific wavelength and transmit the attenuated light with the specific wavelength, an outputter configured to output the light with the specific wavelength transmitted from the attenuator, and a second lens configured to form a focal point to input the light transmitted from the attenuator to the outputter.

According to still another aspect, there is provided a variable optical attenuator including an inputter configured to output input light including a plurality of wavelengths, a first lens configured to convert the input light to focused light or collimated light and allow the focused light or the collimated light to be incident, a plurality of filters configured to reflect a specific wavelength among the wavelengths and transmit a remaining wavelength among the wavelengths, a plurality of attenuators configured to attenuate the input light at a location at which the input light is reflected from the filters and reflect the attenuated input light, an outputter configured to output light with the specific wavelength reflected from the attenuators, and a plurality of optical detectors configured to monitor optical power of the light transmitted from the attenuators.

The first lens may form a focal point to input, to the outputter, the light reflected from the attenuators.

Herein, the attenuator may include a first electrochromic device configured to attenuate an intensity of the input light by controlling a reflectivity and a transmissivity of the input light based on an element included in the first electrochromic device and a voltage to be applied to the first electrochromic device, a filter configured to filter out a remaining wavelength, excluding a specific wavelength, among wavelengths included in light output from the first electrochromic device, and reflect light with the remaining wavelength to the first electrochromic device, and a second electrochromic device configured to attenuate an intensity of light with the specific wavelength transmitted from the filter by controlling a transmissivity of the light with the specific wavelength transmitted from the filter based on an element included in the second electrochromic device and a voltage to be applied to the second electrochromic device.

The first lens may form a focal point to input, to the first outputter, the light with the remaining wavelength reflected from the attenuator.

The variable optical attenuator may further include a second lens configured to form a focal point to input, to the second outputter, the light with the specific wavelength transmitted from the attenuator.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the present disclosure will become apparent and more readily appreciated from the following description of example embodiments, taken in conjunction with the accompanying drawings of which:

FIG. 1 is a diagram illustrating an example of a variable optical attenuator according to an example embodiment;

FIGS. 2A through 2C are diagrams illustrating examples of an electrochromic device according to an example embodiment;

FIG. 3 is a diagram illustrating an example of a variable optical attenuator including a planar transflective electrochromic device according to an example embodiment;

FIG. 4 is a diagram illustrating an example of a variable optical attenuator including a transflective electrochromic device according to an example embodiment;

FIGS. 5A through 5D are diagrams illustrating examples of an electrochromic device of FIG. 4;

FIG. 6 is a diagram illustrating an example of a transmissive variable optical attenuator using a transmissive electrochromic device according to an example embodiment;

FIG. 7 is a diagram illustrating an example of a reflective variable optical attenuator using a reflective electrochromic device according to an example embodiment;

FIG. 8 is a diagram illustrating an example of a variable optical attenuator of FIG. 3 to which a wavelength selecting filter is added according to an example embodiment;

FIG. 9 is a diagram illustrating an example of a variable optical attenuator of FIG. 6 to which a wavelength selecting filter is added according to an example embodiment;

FIG. 10 is a diagram illustrating an example of a variable optical attenuator including a plurality of electrochromic devices and a plurality of wavelength selecting filters according to an example embodiment; and

FIG. 11 is a diagram illustrating an example of a variable optical attenuator including a wavelength selecting filter and a plurality of electrochromic devices according to an example embodiment.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Terms such as first, second, A, B, (a), (b), and the like may be used herein to describe components. Each of these terminologies is not used to define an essence, order, or sequence of a corresponding component but used merely to distinguish the corresponding component from other component(s). For example, a first component may be referred to as a second component, and similarly the second component may also be referred to as the first component.

It should be noted that if it is described in the specification that one component is “connected,” “coupled,” or “joined” to another component, a third component may be “connected,” “coupled,” and “joined” between the first and second components, although the first component may be directly connected, coupled or joined to the second component. In addition, it should be noted that if it is described in the specification that one component is “directly connected” or “directly joined” to another component, a third component may not be present therebetween. Likewise, expressions, for example, “between” and “immediately between” and “adjacent to” and “immediately adjacent to” may also be construed as described in the foregoing.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, operations, elements, and/or components, but do not preclude the presence or addition of one or more other features, integers, operations, elements, components, and/or groups thereof.

Unless otherwise defined, all terms, including technical and scientific terms, used herein have the same meaning as commonly understood by one of ordinary skill in the art to which this disclosure pertains based on an understanding of the present disclosure. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings.

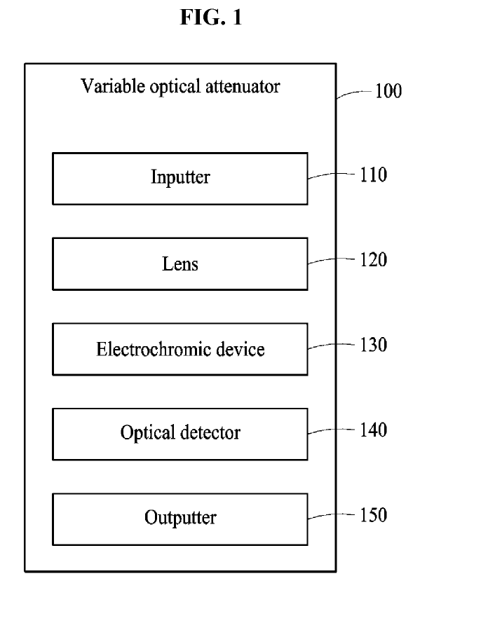

FIG. 1 is a diagram illustrating an example of a variable optical attenuator according to an example embodiment.

According to an example embodiment, a variable optical attenuator 100 may monitor a portion of optical power of input light using an electrochromic device having a transflective property that may adjust a reflectivity and a transmissivity by controlling a voltage and a light absorptivity. In addition, the variable optical attenuator 100 may adjust an intensity of light to be attenuated, or interchangeably referred to as an attenuation intensity of light to be output, by controlling a voltage to be applied to the electrochromic device based on a result of the monitoring, and by adjusting the reflectivity and the transmissivity.

Referring to FIG. 1, the variable optical attenuator 100 includes an inputter 110, a lens 120, an electrochromic device 130, an optical detector 140, and an outputter 150.

The inputter 110 receives input light, which is light input to the variable optical attenuator 100, and emits the received input light to the lens 120. The inputter 110 may be, for example, an input optical fiber.

The lens 120 converts the input light emitted from the inputter 110 to focused light or collimated light, and inputs the focused light or the collimated light to the electrochromic device 130. The lens 120 forms a focal point to input, to the outputter 150, light reflected from the electrochromic device 130.

The electrochromic device 130 controls a reflectivity and a transmissivity of the input light by controlling an absorptivity of the input light based on a voltage to be applied thereto. In detail, the electrochromic device 130 attenuates an intensity of the input light by controlling the reflectivity and the transmissivity of the input light that is input from the lens 120 based on an element included in the electrochromic device 130 and a voltage to be applied to the electrochromic device 130, and outputs the light with the attenuated intensity.

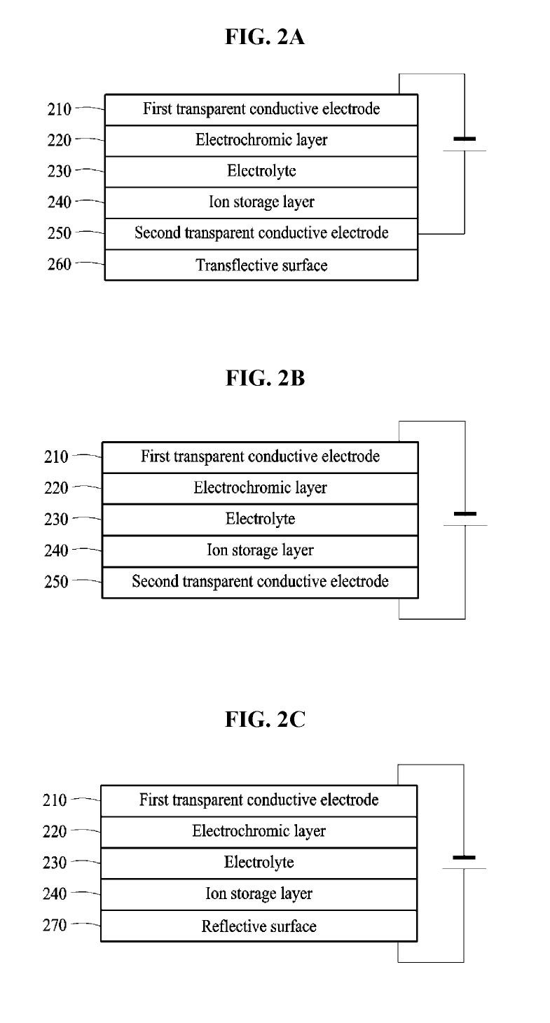

The electrochromic device 130 may have one of a reflective property, a transmissive property, and a transflective property. A structure of each electrochromic device having the reflective property, the transmissive property, or the transflective property will be described in detail with reference to FIGS. 2A, 2B, and 2C.

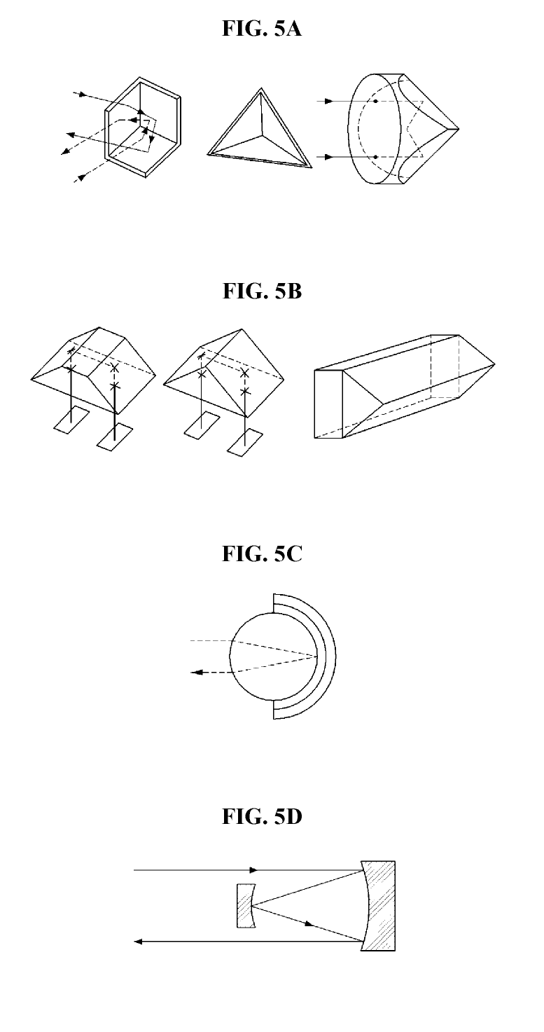

The electrochromic device 130 may be provided in a form having a retro-reflective property. For example, the electrochromic device 130 may include a first face configured to transmit a portion of input light and reflect, at an angle of 90 degrees (°), a remaining portion of the input light that is not transmitted, and a second face configured to reflect the light reflected from the first face in a direction in which the outputter 150 is disposed. A configuration of the electrochromic device 130 provided in such a form having the retro-reflective property will be described in greater detail with reference to FIGS. 5A through 5D.

In a case of the electrochromic device 130 having the transflective property, a portion of input light may be transmitted from the electrochromic device 130, and a remaining portion of the input light may be reflected from the electrochromic device 130. Herein, the optical detector 140 may monitor the portion of the input light transmitted from the electrochromic device 130 having the transflective property. A voltage to be applied to the electrochromic device 130 may be adjusted to be maintained, increased, or decreased based on a result of the monitoring of the light transmitted from the electrochromic device 130 and on a target attenuation intensity value or a target output optical power. For example, in a case in which, although output optical power needs to be maintained consistently, optical power of the light transmitted from the electrochromic device 130 increases, the variable optical attenuator 100 may change a voltage to be applied to the electrochromic device 130 to increase a light intensity to be attenuated, and thus consistently maintain an intensity of light to be output from the outputter 150. For another example, in a case in which, although the output optical power needs to be maintained consistently, the optical power of the light transmitted from the electrochromic device 130 decreases, the variable optical attenuator 100 may change the voltage to be applied to the electrochromic device 130 to reduce the light intensity to be attenuated, and thus consistently maintain the intensity of the light to be output from the outputter 150.

In addition, the electrochromic device 130 may be variable in size based on a size of an area to or through which light is input or passes in a designed structure of the variable optical attenuator 100. A response speed of the electrochromic device 130 with respect to a voltage may increase or decrease in inverse proportion to a size of the electrochromic device 130. For example, as the size of the electrochromic device 130 decreases, the response speed of the electrochromic device 130 may increase. Conversely, as the size of the electrochromic device 130 increases, the response speed of the electrochromic device 130 may decrease.

The outputter 150 outputs the light reflected from the electrochromic device 130 to the outside of the variable optical attenuator 100. The outputter 150 may be, for example, an output optical fiber.

According to an example embodiment, it is possible to adaptively change an intensity of input light to be attenuated, or an attenuation intensity of the input light, by controlling an intensity, or an amount, of reflected or transmitted light using the electrochromic device 130 configured to control a reflectivity and a transmissivity by controlling a light absorptivity based on a voltage to be applied thereto. That is, using the electrochromic device 130 without a physical movement, it is possible to change an attenuation intensity of light, streamline or simplify an optical alignment process and a packaging process due to a more streamlined or simplified structure of a variable optical method using a physical movement, and thus may enhance productivity and reliability.

In addition, it is also possible to adaptively change an intensity of input light to be attenuated based on a change in optical power of the input light by monitoring optical power of the input light using light transmitted from the electrochromic device 130 having the transflective property and changing the intensity of the input light to be attenuated based on a result of the monitoring.

According to an example embodiment, a light absorptivity, a light reflectivity, and a light transmissivity may be changed, without a mechanical movement or an additional polarizing element, by the electrochromic device 130 by adjusting a voltage to be applied thereto.

FIG. 2A is a diagram illustrating illustrates an example of the electrochromic device 130 having a transflective property. Referring to FIG. 2A, the electrochromic device 130 having the transflective property, or also referred to as a transflective electrochromic device 130, includes a first transparent conductive electrode 210, an electrochromic layer 220, an electrolyte 230, an ion storage layer 240, a second transparent conductive electrode 250, and a transflective surface 260.

The electrochromic layer 220, which is one of main elements included in the electrochromic device 130, refers to a layer formed with a cathodic coloration material in which, when an ion and an electron are injected, a light absorptivity changes and a reflectivity and a transmissivity also changes. The ion storage layer 240 refers to a layer formed with an anodic coloration material in which, when an ion and an electron are emitted, a light absorptivity changes and a reflectivity and a transmissivity also changes.

When a voltage is applied to the electrochromic device 130, a pure electron may be conducted from the first transparent conductive electrode 210 to the electrochromic layer 220, and a pure ion may also be conducted from the electrolyte 230 to the electrochromic layer 220. The electrolyte 230 may be, for example, an ion conductor.

In addition, when a voltage is applied to the electrochromic device 130, an ion may be conducted from the ion storage layer 240 to the electrolyte 230, and an electron may be conducted from the ion storage layer 240 to the second transparent conductive electrode 250.

In the electrochromic layer 220 to which the ion is conducted, a reduction reaction may occur due to an inflow of the conducted ion and a light absorptivity may change. In the ion storage layer 240 from which the ion is conducted, an oxidation reaction may occur due to an outflow of the conducted ion and a light absorptivity may change. Thus, a change in light absorptivity may vary based on a type of an element included in the electrochromic device 130, for example, the electrochromic layer 220 and the ion storage layer 240, and on a proportion of the element.

That is, according to an example embodiment, it is possible to attenuate output optical power of light to be reflected or transmitted after the light is input to an electrochromic device by adjusting a voltage to be applied to the electrochromic device and changing a light absorptivity without a physical movement of a device configured to adjust an amount, or an intensity, of light, for example, a shutter and a mirror. In addition, it is also possible to linearly adjust an attenuation ratio of output light by adjusting a voltage to be applied on a low level.

Herein, the first transparent conductive electrode 210 and the second transparent conductive electrode 250 may have light transmissivity and conductivity in response to the voltage being applied. For example, the first transparent conductive electrode 210 and the second transparent conductive electrode 250 may be formed using at least one of tin oxide, indium oxide, a metal nanowire, a carbon nanotube, or conductive polymer. However, materials or substances to be used are not limited to the examples described in the foregoing, and thus any electrodes and electrode materials that have electrical conductivity and transmissivity may also be used.

The transflective surface 260 may transmit a portion of light passing through or transmitted from the first transparent conductive electrode 210, the electrochromic layer 220, the electrolyte 230, the ion storage layer 240, and the second transparent conductive layer 250, and reflect or absorb a remaining portion of the light. For example, the transflective surface 260 may be formed by stacking a single-layer or multilayer thin films, or using a semiconductor substrate or a polymer material having a partial transmission property in a certain wavelength region.

The transflective electrochromic device 130 may adjust a reflectivity and a transmissivity of light to be transmitted based on at least one of a type of the semiconductor substrate, a type of a material or substance included in the thin films, a type of the polymer material, a thickness, or a structure. Thus, the transflective electrochromic device 130 may adjust the reflectivity and transmissivity in a wider range compared to a transmissive electrochromic device and a reflective electrochromic device that do not include the transflective surface 260, and may thus have a wider range of a controllable attenuation intensity compared to the transmissive electrochromic device and the reflective electrochromic device that do not include the transflective surface 260.

FIG. 2B is a diagram illustrating an example of the electrochromic device 130 having a transmissive property. Referring to FIG. 2B, the electrochromic device 130 having the transmissive property, or also referred to as a transmissive electrochromic device 130, includes a first transparent conductive electrode 210, an electrochromic layer 220, an electrolyte 230, an ion storage layer 240, and a second transparent conductive electrode 250.

The transmissive electrochromic device 130 does not include the transflective surface 260 of FIG. 2A, and thus light that has passed through the first transparent conductive electrode 210, the electrochromic layer 220, the electrolyte 230, the ion storage layer 240, and the second transparent conductive electrode 250 may be transmitted from the transmissive electrochromic device 130.

FIG. 2C is a diagram illustrating an example of the electrochromic device 130 having a reflective property. Referring to FIG. 2C, the electrochromic device 130 having the reflective property, or also referred to as a reflective electrochromic device 130, includes a first transparent conductive electrode 210, an electrochromic layer 220, an electrolyte 230, an ion storage layer 240, and a reflective surface 270.

The reflective surface 270 may reflect light that has passed through the first transparent conductive electrode 210, the electrochromic layer 220, the electrolyte 230, and the ion storage layer 240. The reflective surface 270 may be formed with a highly reflective and conductive metal, such as, for example, aluminum, gold, silver, platinum, and copper.

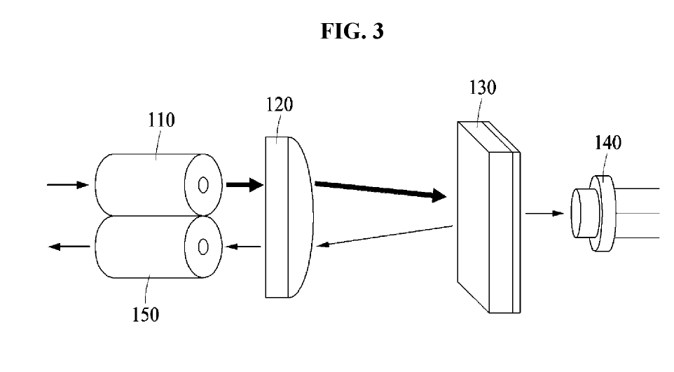

FIG. 3 is a diagram illustrating an example of a variable optical attenuator including a planar transflective electrochromic device according to an example embodiment.

Referring to FIG. 3, a lens 120 converts input light that has passed through an inputter 110 to focused light or collimated light, and inputs the focused light or the collimated light to an electrochromic device 130. Herein, a portion of the input light that is input to the electrochromic device 130 is transmitted from the electrochromic device 130, and a remaining portion of the input light that has not been transmitted through or absorbed in the electrochromic device 130 is reflected from the electrochromic device 130 and then input back to the lens 120.

The lens 120 forms a focal point on an outputter 150 such that the light reflected from the electrochromic device 130 is input to the outputter 150.

An optical detector 140 extracts input optical power of the input light that is initially input to the inputter 110 by monitoring the light transmitted from the electrochromic device 130. Herein, the variable optical attenuator 100 controls a voltage to be applied to the electrochromic device 130 based on the extracted input optical power, and controls an amount, or an intensity, of output light while changing an absorptivity, a reflectivity, and a transmissivity by the electrochromic device 130.

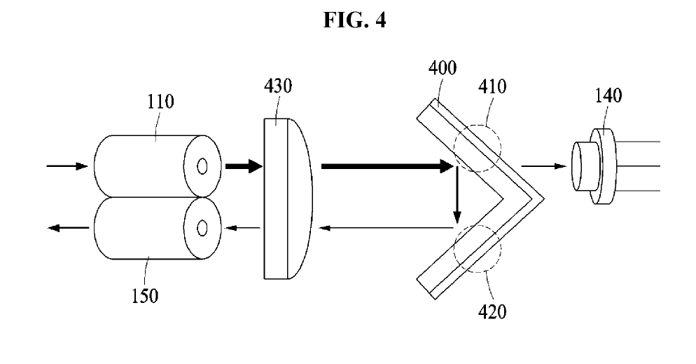

FIG. 4 is a diagram illustrating an example of a variable optical attenuator including a transflective electrochromic device according to an example embodiment.

FIG. 4 illustrates a variable optical attenuator including a prismatic transflective electrochromic device 400 having a retro-reflection type reflective property, which is an alternative example to the planar transflective electrochromic device 130 illustrated in FIG. 3.

Referring to FIG. 4, the transflective electrochromic device 400 includes a first face 410 and a second face 420 that form an angle of 90° therebetween. The first face 410 is disposed to form an angle of 45° with a straight line parallel to an inputter 110, and the second face 420 is disposed to form an angle of 45° with a straight line parallel to an outputter 150.

A lens 430 converts input light that has passed through the inputter 110 to focused light or collimated light, and inputs the focused light or the collimated light to the first face 410 of the transflective electrochromic device 400. Herein, a portion of the input light that is input to the transflective electrochromic device 400 is transmitted from the first face 410, and a remaining portion of the input light that has not been transmitted from or absorbed in the first face 410 is reflected from the first face 410 to the second face 420 as illustrated in FIG. 4. The light reflected from the first face 410 to the second face 420 is reflected from the second face 420 and then input to the lens 430. Herein, light that has passed through the lens 430 is input to the outputter 150.

According to an example embodiment, the variable optical device of FIG. 4 may attenuate light by each of the first face 410 and the second face 420 of the transflective electrochromic device 400, and thus may have a wider range of attenuation compared to the variable optical attenuator of FIG. 3 that may attenuate light by a single face.

FIGS. 5A through 5D are diagrams illustrating examples of the electrochromic device 400 illustrated in FIG. 4.

The electrochromic device 400 may be provided in one of a cube corner type as illustrated in FIG. 5A, a prism type as illustrated in FIG. 5B, a cat's-eye type as illustrated in FIG. 5C, and a cat's-eye primary mirror type as illustrated in FIG. 5D. However, a type of the electrochromic device 400 is not limited to the example types illustrated in FIGS. 5A through 5D, and thus any type, form, or structure that may reflect input light in various paths and return the reflected light to an output optical fiber may also be used.

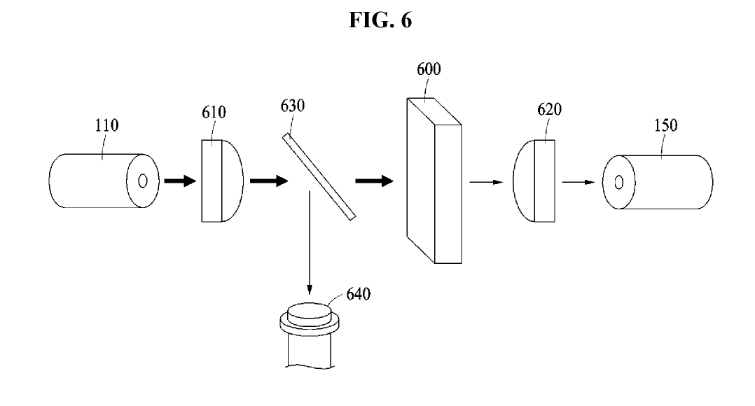

FIG. 6 is a diagram illustrating an example of a variable optical attenuator using a transmissive electrochromic device 600 according to an example embodiment.

Referring to FIG. 6, the variable optical attenuator includes the transmissive electrochromic device 600 having a transmissive property, a first lens 610 configured to convert input light to focused light or collimated light and input the focused light or the collimated light to the electrochromic device 600, a filter 630 configured to split a portion of input light, an optical detector 640 configured to detect optical power of the light split by the filter 630 and monitor total input optical power of the input light, and a second lens 620 configured to form a focal point such that light transmitted from the electrochromic device 600 is input to an outputter 150. Herein, a voltage to be applied to the electrochromic device 600 may be determined based on a result of the monitoring of the input optical power such that output light corresponding to a target attenuation intensity or target output optical power is output through the outputter 150, and thus it is possible to adjust a transmissivity of the transmissive electrochromic device 600.

As illustrated in FIG. 6, an in-line configuration of an inputter 110, the first lens 610, the filter 630, the transmissive electrochromic device 600, the second lens 620, and the outputter 150 of the variable optical attenuator may facilitate an optical alignment and streamline a packaging process. Thus, the variable optical attenuator may be effective to reduce a process cost and enhance productivity. In addition, the variable optical attenuator may monitor input optical power through a filter disposed between the first lens 610 and the transmissive electrochromic device 600, for example, the filter 630, or a filter disposed between the transmissive electrochromic device 600 and the second lens 620.

Alternatively, the variable optical attenuator may use a simple method of combining an optical element configured to split a portion of input light, for example, a splitter and the like in lieu of the filter 630, and an optical detector, for example, the optical detector 640, to monitor the input optical power. The variable optical attenuator may adjust a transmissivity of the transmissive electrochromic device 600 based on a result of the monitoring, and control optical power of output light to be transmitted.

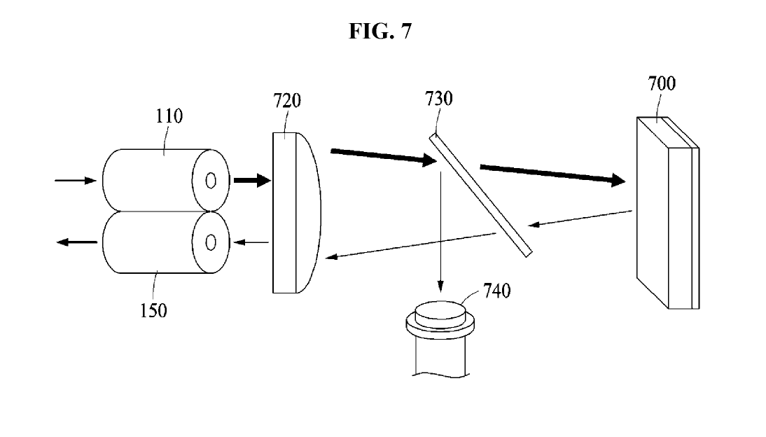

FIG. 7 is a diagram illustrating an example of a reflective variable optical attenuator in which an inputter 110 and an outputter 150 are disposed in a same direction, and using a reflective electrochromic device 700 according to an example embodiment.

Referring to FIG. 7, a lens 720 converts input light that has passed through the inputter 110 to focused light or collimated light, and inputs the focused light or the collimated light to the reflective electrochromic device 700. The light input to the reflective electrochromic device 700 is reflected from the electrochromic device 700 and then input to the lens 720. Herein, the reflective electrochromic device 700 may control a reflectivity or reflectance of the input light and attenuate an intensity of the reflected light based on a voltage to be applied thereto.

The lens 720 forms a focal point on the outputter 150 such that the light reflected from the reflective electrochromic device 700 is input to the outputter 150.

As illustrated in FIG. 7, the variable optical attenuator may monitor input optical power by adding, between the lens 720 and the reflective electrochromic device 700, a filter 730 configured to split a portion of the input light and an optical detector 740. The variable optical attenuator may adjust a reflectivity of the reflective electrochromic device 700 based on a result of the monitoring, and thus control optical power of the reflected light to correspond to a target attenuation ratio or target output optical power.

Alternatively, the variable optical attenuator may monitor input optical power of input light by combining an optical element configured to split a portion of the input light, for example, a splitter in lieu of the filter 730, and an optical detector Herein, the variable optical attenuator may control optical power of output light to be reflected based on a result of the monitoring.

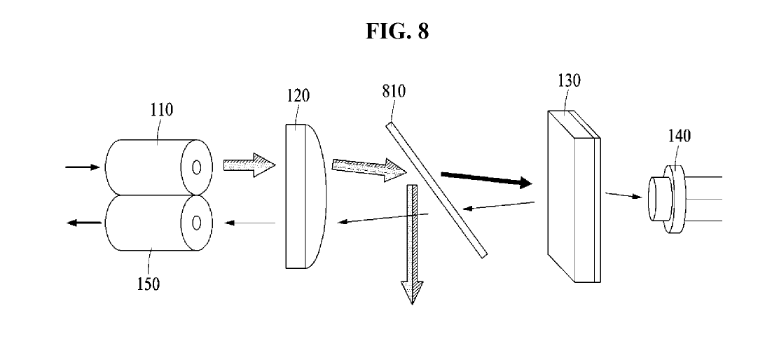

FIG. 8 is a diagram illustrating an example of a variable optical attenuator provided by adding, to the variable optical attenuator of FIG. 3, a wavelength selecting filter 810 configured to filter out a remaining wavelength, excluding a specific wavelength, among wavelengths included in input light.

Referring to FIG. 8, when the input light output from an inputter 110 includes three wavelengths, the wavelength selecting filter 810 filters out two wavelengths among the three wavelengths included in the input light that has passed through a lens 120 and reflects the two wavelengths, and transmits only one specific wavelength.

An electrochromic device 130 transmits a portion of light with the specific wavelength transmitted from the wavelength selecting filter 810, and reflects a remaining portion of the light, and thus may attenuate an amount, or an intensity, of the light with the specific wavelength transmitted from the wavelength selecting filter 810. Herein, the variable optical attenuator may monitor the light transmitted from the electrochromic device 130 using an optical detector 140. The variable optical attenuator may thus adaptively obtain a desired attenuation ratio or desired output optical power by controlling a voltage to be applied to the electrochromic device 130 based on a result of the monitoring. Further, it is also possible to embody a reflective variable optical attenuator configured to filter out a remaining wavelength, excluding a specific wavelength, by replacing the electrochromic device 130 with the reflective electrochromic device 700 as illustrated in FIG. 7 and removing the optical detector 140.

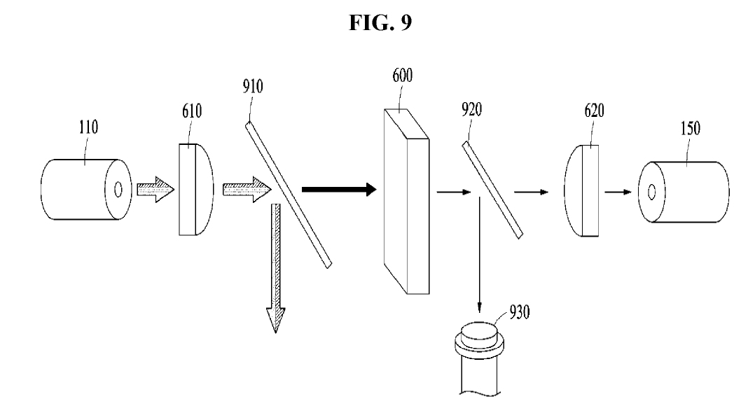

FIG. 9 is a diagram illustrating an example of a variable optical attenuator provided by adding, to the variable optical attenuator of FIG. 6, a wavelength selecting filter 910 configured to filter out a remaining wavelength, excluding a specific wavelength, among wavelengths included in input light.

Referring to FIG. 9, when the input light output from an inputter 110 includes three wavelengths, the wavelength selecting filter 910 filters out two wavelengths among the three wavelengths included in the input light that has passed through a lens 120 and reflects the two wavelengths, and transmits only one specific wavelength.

An electrochromic device 600 transmits a portion of light with the specific wavelength transmitted from the wavelength selecting filter 910, and attenuates an amount, or an intensity, of the light with the specific wavelength transmitted from the wavelength selecting filter 910. The variable optical attenuator may thus monitor a portion of light transmitted from the electrochromic device 600 using a filter 920 configured to selectively split wavelengths of the light transmitted from the electrochromic device 600 and an optical detector 930. Further, the variable optical attenuator may adaptively obtain a desired attenuation ratio or desired output optical power by controlling a voltage to be applied to the electrochromic device 600 based on a result of the monitoring.

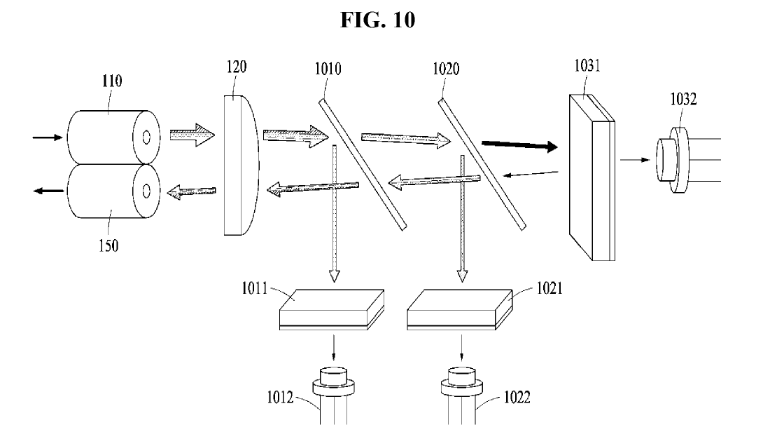

FIG. 10 is a diagram illustrating an example of a variable optical attenuator including a plurality of electrochromic devices and a plurality of wavelength selecting filters according to an example embodiment.

The variable optical attenuator illustrated in FIG. 10 may attenuate each of wavelengths included in input light using a plurality of electrochromic devices and wavelength selecting filters.

Referring to FIG. 10, when the input light that is output from an inputter 110 includes a first wavelength, a second wavelength, and a third wavelength, a first wavelength selecting filter 1010 filters out the first wavelength among the three wavelengths included in the input light that has passed through a lens 120 and reflects the first wavelength downwards, and transmits the second wavelength and the third wavelength.

Herein, a first electrochromic device 1011 transmits a portion of light with the first wavelength reflected from the first wavelength selecting filter 1010, and absorbs or reflects a remaining portion of the light with the first wavelength. A first optical detector 1012 monitors the light transmitted from the first electrochromic device 1011 and determines optical power of the first wavelength. The light with the first wavelength reflected from the first electrochromic device 1011 is reflected in a direction from the first wavelength selecting filter 1010 to the lens 120 and then output to an outputter 150.

In addition, a second wavelength selecting filter 1020 filters out the second wavelength of the two wavelengths, the second wavelength and the third wavelength, that are transmitted from the first wavelength selecting filter 1010 and reflects the second wavelength downwards, and transmits the third wavelength.

Herein, a second electrochromic device 1021 transmits a portion of light with the second wavelength reflected from the second wavelength selecting filter 1020, and absorbs or reflects a remaining portion of the light with the second wavelength. A second optical detector 1022 monitors the light transmitted from the second electrochromic device 1021 and determines optical power of the second wavelength. The light with the second wavelength reflected from the second electrochromic device 1021 is reflected in a direction from the second wavelength selecting filter 1020 to the first wavelength selecting filter 1010 and then output to the outputter 150.

In addition, a third electrochromic device 1031 transmits a portion of light with the third wavelength transmitted from the second wavelength selecting filter 1020, and absorbs or reflects a remaining portion of the light with the third wavelength. A third optical detector 1032 monitors the light transmitted from the third electrochromic device 1031 and determines optical power of the third wavelength. The light with the third wavelength reflected from the third electrochromic device 1031 passes through the second wavelength selecting filter 1020 and the first wavelength selecting filter 1010 to be output to the outputter 150.

According to an example embodiment, the variable optical attenuator may monitor a first wavelength, a second wavelength, and a third wavelength included in input light using different optical detectors, and adjust a voltage to be applied to each of electrochromic devices based on a result of the monitoring. Thus, the variable optical attenuator may adaptively obtain a desired attenuation ratio or desired output optical power for each of the input wavelengths. The variable optical attenuator may attenuate light for each wavelength, and it is thus possible to enable individually variable optical attenuation for multi-channel input optical wavelengths using a single variable optical attenuator, and facilitate channel expansion.

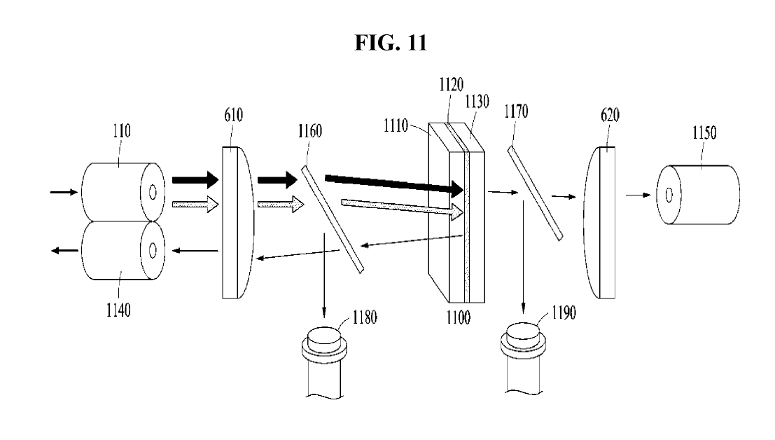

FIG. 11 is a diagram illustrating an example of a variable optical attenuator including a wavelength selecting filter and a plurality of electrochromic devices according to an example embodiment.

Referring to FIG. 8, the variable optical attenuator selectively attenuates input light with multiple wavelengths that is incident on a single inputter 130, using a plurality of electrochromic devices and a wavelength selecting filter 1120 disposed thereamong, and outputs the attenuated light to each of a first outputter 1140 and a second outputter 1150.

Using an attenuator 1100 including the electrochromic devices and the wavelength selecting filter 1120, the variable optical attenuator attenuates a specific wavelength transmitted from the wavelength selecting filter 1120 among the wavelengths included in the input light and then transmits the attenuated specific wavelength, and attenuates a remaining wavelength excluding the specific wavelength and then reflects the attenuated remaining wavelength from the wavelength selecting filter 1120. As illustrated in FIG. 11, the attenuator 1100 includes a first electrochromic device 1100, the wavelength selecting filter 1120, and a second electrochromic device 1130.

The first electrochromic device 1110 controls an absorptance, a reflectance, and a transmittance of input light based on a voltage to be applied thereto and attenuates an amount, or an intensity, of the input light.

The wavelength selecting filter 1120 filters out a remaining wavelength excluding a specific wavelength among wavelengths included in light output from the first electrochromic device 1110, and reflects the remaining wavelength to the first electrochromic device 1110 and transmits the specific wavelength to the second electrochromic device 1130. Herein, the wavelength selecting filter 1120 may be replaced with a deposited single layer or a multi-layer thin film to transmit a specific wavelength among multiple wavelengths and reflect a remaining wavelength, excluding the specific wavelength, among the multiple wavelengths.

The remaining wavelength reflected to the first electrochromic device 1110 passes through a first lens 610 and is then input to the first outputter 1140. The first lens 610 forms a focal point to input light with the remaining wavelength to the first outputter 1140.

The second electrochromic device 1130 controls a transmittance of the light with the specific wavelength that has passed through the wavelength selecting filter 1120 based on a voltage to be applied thereto and attenuates an amount, or an intensity, of the light with the specific wavelength that has passed through the wavelength selecting filter 1120.

The light with the specific wavelength attenuated in and transmitted from the second electrochromic device 1130 passes through a second lens 620 and is then input to the second outputter 1150. The second lens 620 forms a focal point to input, to the second outputter 1150, the light with the specific wavelength that is transmitted from the second electrochromic device 1130 while being attenuated therein.

The variable optical attenuator controls a voltage to be applied to the first electrochromic device 1110 to change an attenuation ratio of the remaining wavelength to be output to the first outputter 1140. Similarly, the variable optical attenuator controls a voltage to be applied to the second electrochromic device 1130 to change an attenuation ratio of the specific wavelength to be output to the second outputter 1150.

In addition, the variable optical attenuator monitors each of the wavelengths of the input light using filters 1160 and 1170 configured to selectively split the wavelengths of the input light, and optical detectors 1180 and 1190. The variable optical attenuator controls a voltage to be applied to each of the first electrochromic device 1110 and the second electrochromic device 1130 such that the variable optical attenuator adaptively obtains a desired attenuation ratio or desired output optical power based on a result of the monitoring.

As discussed above, the variable optical attenuator may control each of respective attenuation ratios of the wavelengths included in the input light using the attenuator 1100 including the plurality of electrochromic devices.

According to example embodiments described herein, it is possible to adaptively change an intensity of input light to be attenuated by controlling an amount, or an intensity, of light to be reflected or transmitted using an electrochromic device configured to control a reflectivity or a transmissivity by adjusting a light absorptivity based on a voltage to be applied thereto.

According to example embodiments described herein, it is possible to adaptively change an intensity of input light to be attenuated based on a change in optical power of the input light by monitoring the optical power of the input light using light transmitted from an electrochromic device having a transflective property, and by changing the intensity of the input light to be attenuated based on a result of the monitoring.

While the present disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A variable optical attenuator comprising:
an electrochromic device having a reflective property or a transflective property;
a lens configured to convert input light to focused light or collimated light and input the focused light or the collimated light to the electrochromic device; and
an outputter configured to output light reflected from the electrochromic device,
wherein the electrochromic device is configured to attenuate an intensity of the input light by controlling a reflectivity and a transmissivity of the input light based on an element included in the electrochromic device and a voltage to be applied to the electrochromic device.

2. The variable optical attenuator of claim 1, when the electrochromic device has the transflective property, further comprising:
an optical detector configured to monitor a portion of the input light transmitted from the electrochromic device,
wherein the voltage to be applied to the electrochromic device is determined based on a result of the monitoring of the light transmitted from the electrochromic device.

3. The variable optical attenuator of claim 1, when the electrochromic device has the reflective property, further comprising:
a filter configured to split a portion of the input light before the input light is input to the electrochromic device; and
an optical detector configured to monitor the split light,
wherein the voltage to be applied to the electrochromic device is determined based on a result of the monitoring by the optical detector.

4. The variable optical attenuator of claim 1, wherein the electrochromic device comprises:
a first face configured to transmit a portion of the input light and reflect, at an angle of 90 degrees (°), a remaining portion of the input light that is not transmitted; and
a second face configured to reflect the light reflected from the first face in a direction in which the outputter is disposed.

5. The variable optical attenuator of claim 1, further comprising:
a filter configured to filter out a remaining wavelength, excluding a specific wavelength, among wavelengths included in the input light,
wherein the electrochromic device is configured to attenuate an intensity of light with the specific wavelength transmitted from the filter.

6. The variable optical attenuator of claim 1, wherein the lens is configured to form a focal point to input, to the outputter, the light reflected from the electrochromic device.

7. The variable optical attenuator of claim 1, when the electrochromic device has the transflective property, further comprising:
a plurality of wavelength selecting filters configured to perform filtering to selectively transmit, to the electrochromic device, light with a specific wavelength among wavelengths included in the input light; and
an optical detector configured to monitor the light with the specific wavelength transmitted from the electrochromic device,
wherein the voltage to be applied to the electrochromic device is determined based on a result of the monitoring of the light transmitted from the electrochromic device.

8. A variable optical attenuator comprising:
an electrochromic device having a transmissive property;
a first lens configured to convert input light to focused light or collimated light and input the focused light or the collimated light to the electrochromic device; and
an outputter configured to output the input light transmitted from the electrochromic device,
wherein the electrochromic device is configured to attenuate an intensity of the input light by controlling a transmissivity of the input light based on an element included in the electrochromic device and a voltage to be applied to the electrochromic device.

9. The variable optical attenuator of claim 8, further comprising:
a second lens configured to form a focal point to input, to the outputter, the light transmitted from the electrochromic device.

10. The variable optical attenuator of claim 8, further comprising:
a filter configured to split a portion of the input light before the input light is input to the electrochromic device or a portion of the light after the light is transmitted from the electrochromic device; and
an optical detector configured to monitor the split light,
wherein the voltage to be applied to the electrochromic device is determined based on a result of the monitoring by the optical detector.

11. The variable optical attenuator of claim 8, further comprising:
a filter configured to filter out a remaining wavelength, excluding a specific wavelength, among wavelengths included in the input light,
wherein the electrochromic device is configured to attenuate an intensity of light with the specific wavelength transmitted from the filter.

12. A variable optical attenuator comprising:
an inputter configured to output input light including a plurality of wavelengths;
a first lens configured to convert the input light to focused light or collimated light and input the focused light or the collimated light to an attenuator;
the attenuator configured to attenuate light with a specific wavelength among the wavelengths of the input light and transmit the attenuated light with the specific wavelength, and attenuate light with a remaining wavelength, excluding the specific wavelength, among the wavelengths of the input light and reflect the attenuated light with the remaining wavelength;
a first outputter configured to output the light with the remaining wavelength; and
a second outputter configured to output the light with the specific wavelength.

13. The variable optical attenuator of claim 12, wherein the attenuator comprises:
a first electrochromic device configured to attenuate an intensity of the input light by controlling a reflectivity and a transmissivity of the input light based on an element included in the first electrochromic device and a voltage to be applied to the first electrochromic device;
a filter configured to filter out a remaining wavelength, excluding a specific wavelength, among wavelengths included in light output from the first electrochromic device, and reflect light with the remaining wavelength to the first electrochromic device; and
a second electrochromic device configured to attenuate an intensity of light with the specific wavelength transmitted from the filter by controlling a transmissivity of the light with the specific wavelength transmitted from the filter based on an element included in the second electrochromic device and a voltage to be applied to the second electrochromic device.

14. The variable optical attenuator of claim 12, wherein the first lens is configured to form a focal point to input, to the first outputter, the light with the remaining wavelength reflected from the attenuator.

15. The variable optical attenuator of claim 12, further comprising:
a second lens configured to form a focal point to input, to the second outputter, the light with the specific wavelength transmitted from the attenuator.

16. The variable optical attenuator of claim 13, further comprising:
a filter configured to split a portion of the input light before the input light is input to the first electrochromic device or a portion of light output from the first electrochromic device; and
an optical detector configured to monitor the split light,
wherein the voltage to be applied to the first electrochromic device is determined based on a result of the monitoring by the optical detector.
